(19) United States
(12) Patent Application Publication
(10) Pub. No.: US 2026/0221338 A1
(43) Pub. Date: Jul. 30, 2026

(54) SINTERED MAGNET, METHOD FOR MAKING SINTERED MAGNET AND PRESSING MOLD

(71) Applicant: TDK Corporation, Tokyo (JP)

(72) Inventors: Shota MIYAZAKI, Tokyo (JP); Nobuyuki SHIMBO, Tokyo (JP); Masaki TOMITA, Tokyo (JP)

(73) Assignee: TDK Corporation, Tokyo (JP)

(21) Appl. No.: 19/462,352

(22) Filed: Jan. 28, 2026

(30) Foreign Application Priority Data
Jan. 30, 2025 (JP) 2025-013565
Dec. 26, 2025 (JP) 2025-284139

(51) Int. Cl. H01F 41/02; H01F 7/02; H01F 13/00

(52) U.S. Cl. CPC H01F 41/0266; H01F 7/021; H01F 13/003

(57) ABSTRACT

A pressing mold is provided with a pair of second yoke portions, and the magnetic flux of a magnetic field applied during press-molding can be adjusted by the pair of second yoke portions. By correcting local disturbances in the magnetic flux, it is possible to approach an ideal magnetic field orientation that is generally along the magnetization direction, and uniformization of the magnetic field distribution is realized.

### CROSS-REFERENCE TO RELATED APPLICATIONS

This application is based upon and claims the benefit of priority from Japanese Patent Application No. 2025-13565, filed on 30 Jan. 2025, and Japanese Patent Application No. 2025-284139, filed on 26 Dec. 2025, and the entire contents of which are incorporated herein by reference.

### TECHNICAL FIELD

The present disclosure relates to a sintered magnet, a method for making a sintered magnet, and a pressing mold.

### BACKGROUND

Known in the art is a sintered magnet having a magnetization direction in a uniaxial direction (i.e., uniaxial anisotropy). Such a sintered magnet is widely used in a device, for example, a motor, a generator, an electromagnetic actuator, and an electromagnetic sensor.

In recent years, the introduction of renewable energy has been promoted as a measure against global warming, and wind power generation is one example. For a sintered magnet installed in a wind power generator, the higher its magnetic properties, the higher the output can be, and the magnetic properties are enhanced by highly orienting the sintered magnet.

Japanese Unexamined Patent Application Publication No. 1987-276812 discloses a technology for increasing the degree of orientation of a magnet by press-molding magnetic powder filled in a mold while applying a concentrated high magnetic field.

### SUMMARY

The magnetic field distribution of the high magnetic field in the related art described above is determined according to the magnetic pole size of the electromagnet coils for generating the magnetic field, the distance between the magnetic poles, and the like. Since the magnetic flux lines generated between the electromagnet coils tend to deviate more as the distance from the center of the electromagnet coils increases, the magnetic field distribution within the mold is less likely to be uniform, especially when forming a large sintered magnet such as one installed in a wind power generator, and sections where the magnetic field is weak or where the magnetic flux lines deviate may occur locally. In this case, the degree of orientation of the sintered magnet obtained by sintering the press-molded magnetic powder is reduced.

According to various aspects of the present disclosure, provided are a sintered magnet, a method for making a sintered magnet, and a pressing mold that improve the uniformity of a magnetic field distribution.

A method for making a sintered magnet according to one aspect of the present disclosure is a method for making a sintered magnet using a pressing mold including a main body having an opening to be filled with magnetic powder and extending in a first direction, and a yoke arranged around the opening of the main body in a cross-section orthogonal to the first direction. The method includes steps of, forming a green compact by pressing the magnetic powder filled in the opening in the first direction while applying a magnetic field along a second direction orthogonal to the first direction, and forming a sintered magnet by sintering the green compact. In a cross-section orthogonal to the first direction, the opening has a rectangular shape defined by two sides extending in the second direction and two sides extending in a third direction orthogonal to the first direction and the second direction. And, the yoke includes, in a cross-section orthogonal to the first direction, a pair of first yoke portions sandwiching the opening in the second direction, and a pair of second yoke portions sandwiching the opening in the third direction.

A pressing mold according to one aspect of the present disclosure is a pressing mold for pressing magnetic powder filled in an opening of a main body in a first direction while applying a magnetic field along a second direction orthogonal to the first direction. The pressing mold includes a main body having an opening to be filled with the magnetic powder and extending in the first direction, and a yoke arranged around the opening of the main body in a cross-section orthogonal to the first direction. In a cross-section orthogonal to the first direction, the opening has a rectangular shape defined by two sides extending in the second direction and two sides extending in a third direction orthogonal to the first direction and the second direction. And, the yoke includes, in a cross-section orthogonal to the first direction, a pair of first yoke portions sandwiching the opening in the second direction, and a pair of second yoke portions sandwiching the opening in the third direction.

### BRIEF DESCRIPTION OF THE DRAWINGS

FIG. 1 is a schematic perspective view showing a pressing mold according to an embodiment.

FIG. 2 is a schematic perspective view showing a tubular portion of the pressing mold shown in FIG. 1.

FIG. 3 is a schematic perspective view showing a yoke of the pressing mold shown in FIG. 1.

FIG. 4 is a cross-sectional view of the pressing mold shown in FIG. 1, taken along line IV-IV.

FIG. 5 is a flowchart showing procedures of the method for making the sintered magnet using the pressing mold shown in FIG. 1.

FIGS. 6A, 6B, and 6C are diagrams showing the state of the pressing step of the flowchart of FIG. 5.

FIG. 7 is a schematic perspective view showing a sintered magnet.

FIGS. 8A, 8B, and 8C are diagrams showing the magnetic field orientation of the sintered magnet.

FIG. 9 is a cross-sectional view showing the pressing mold of a different form.

FIG. 10 is a cross-sectional view showing the pressing mold of a different form.

FIG. 11 is a cross-sectional view showing the pressing mold of a different form.

FIG. 12 is a table showing the results of a simulation according to Example 1.

FIG. 13 is a table showing the results of the simulation according to Example 1.

FIG. 14 is a table showing the results of the simulation according to Example 1.

FIG. 15 is a table showing the results of the simulation according to Example 1.

FIG. 16 is a table showing the results of a simulation according to Example 2.

FIG. 17 is a table showing the results of the simulation according to Example 2.

FIG. 18 is a table showing the results of the simulation according to Example 2.

FIG. 19 is a table showing the results of the simulation according to Example 2.

FIG. 20 is a table showing the results of the simulation according to Example 2.

FIG. 21 is a table showing the results of the simulation according to Example 2.

FIG. 22 is a table showing the results of the simulation according to Example 2.

FIG. 23 is a table showing the results of the simulation according to Example 2.

FIG. 24 is a table showing the results of the simulation according to Example 2.

FIG. 25 is a table showing the results of the simulation according to Example 2.

FIG. 26 is a table showing the results of a simulation according to Example 3.

FIG. 27 is a table showing the results of the simulation according to Example 3.

FIG. 28 is a table showing the results of the simulation according to Example 3.

FIG. 29 is a table showing the results of the simulation according to Example 3.

FIG. 30 is a table showing the results of the simulation according to Example 3.

FIG. 31 is a table showing the results of the simulation according to Example 3.

FIG. 32 is a table showing the results of the simulation according to Example 3.

FIG. 33 is a table showing the results of the simulation according to Example 3.

### DETAILED DESCRIPTION

Hereinafter, embodiments of the present disclosure will be described in detail with reference to the accompanying drawings. In the description of the drawings, the same or corresponding elements are denoted by the same reference numerals, and redundant descriptions are omitted.

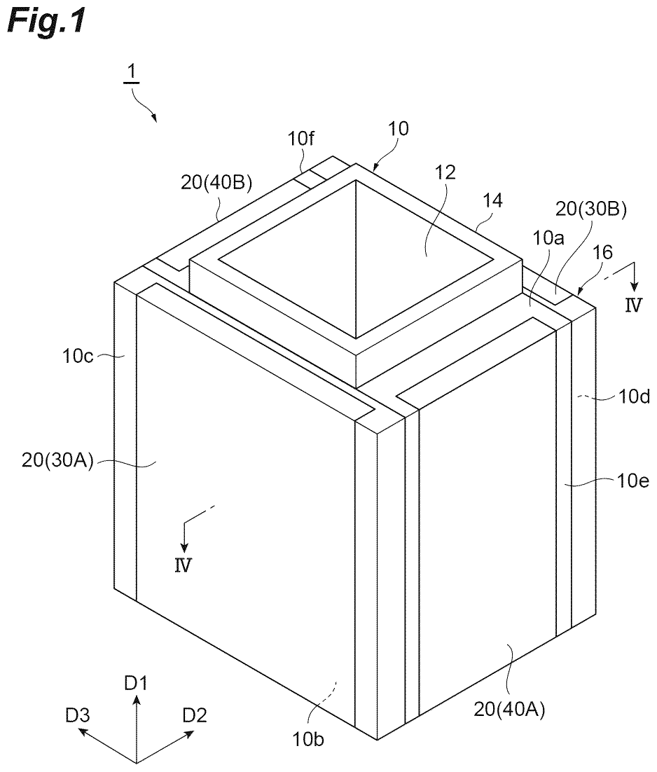

First, a pressing mold 1 according to an embodiment will be described with reference to FIGS. 1 to 4. The pressing mold 1 is configured to include a main body 10 and a yoke 20.

In the present embodiment, the main body 10 is configured to include a tubular portion 14 having an opening 12 and a surrounding portion 16.

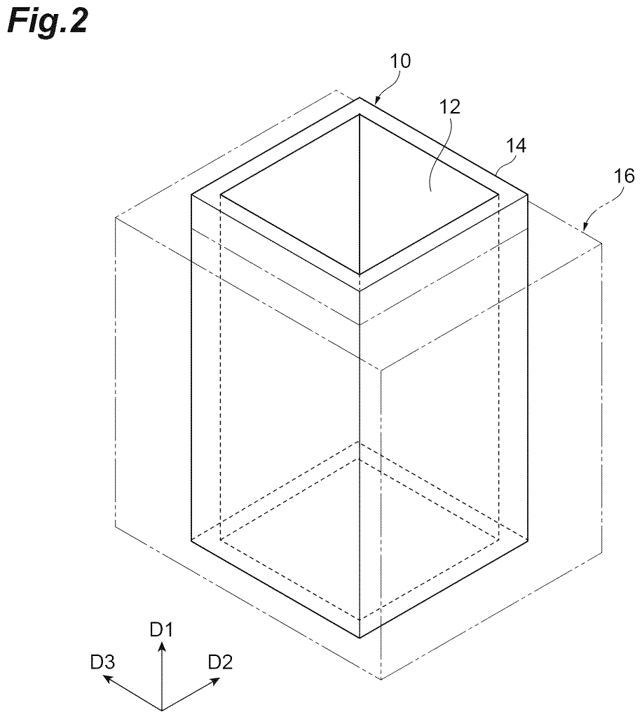

As shown in FIG. 2, the tubular portion 14 has a rectangular tube shape extending in one direction, and an opening 12 with a rectangular cross-section is formed inside thereof along the extending direction. In present embodiment, the opening 12 has a substantially square cross-section (for example, 60 mm×60 mm). The opening 12 can also have a substantially rectangular cross-section (for example, 120 mm×80 mm, 60 mm×200 mm, etc.). The tubular portion 14 can be made of, for example, a non-magnetic material, or can be made of a cemented carbide or carbon steel, which corresponds to a soft magnetic material. Hereinafter, the extending direction of the opening 12 and the extending direction of the tubular portion 14 are also referred to as a first direction D1.

The surrounding portion 16 is a portion that covers the tubular portion 14 from its outer peripheral side, and covers all four outer peripheral surfaces of the tubular portion 14. In present embodiment, the surrounding portion 16 has a substantially rectangular tube-like outer shape, and has an upper surface 10a and a lower surface 10b facing each other in the first direction D1, as well as four side surfaces 10c to 10f. Hereinafter, the direction in which the side surface 10c and the side surface 10d face each other is also referred to as a second direction D2, and the direction in which the side surface 10e and the side surface 10f face each other is also referred to as a third direction D3. The second direction D2 is a direction orthogonal to the first direction D1, and the third direction D3 is a direction orthogonal to the first direction D1 and the second direction D2. In present embodiment, the length of the surrounding portion 16 with respect to the first direction D1 is designed to be shorter than the length of the tubular portion 14, and the tubular portion 14 protrudes upward from the upper surface 10a of the surrounding portion 16. The surrounding portion 16 may be composed of a plurality of members, or may be composed of a single member. In present embodiment, the surrounding portion 16 is composed of four members that respectively constitute the four side surfaces 10c to 10f. The surrounding portion 16 can be made of, for example, a non-magnetic material (specifically, stainless steel or the like).

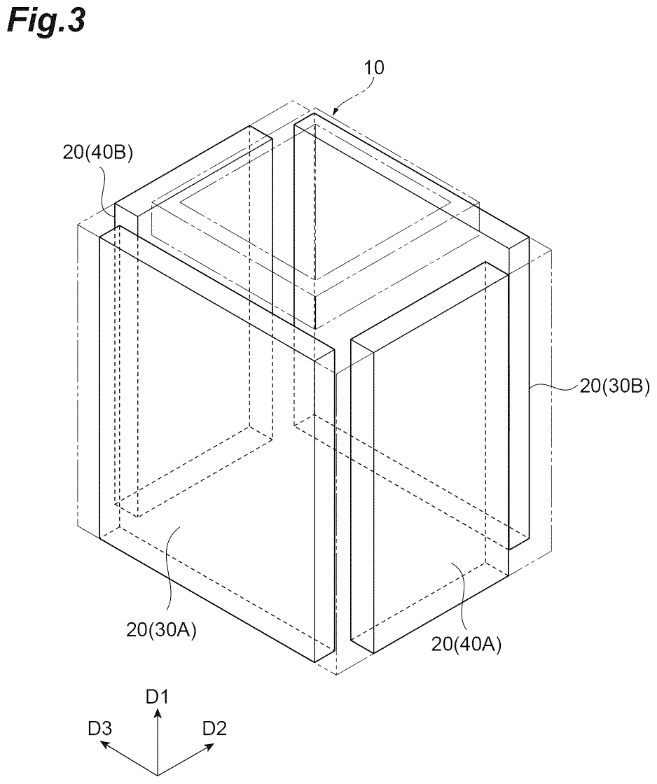

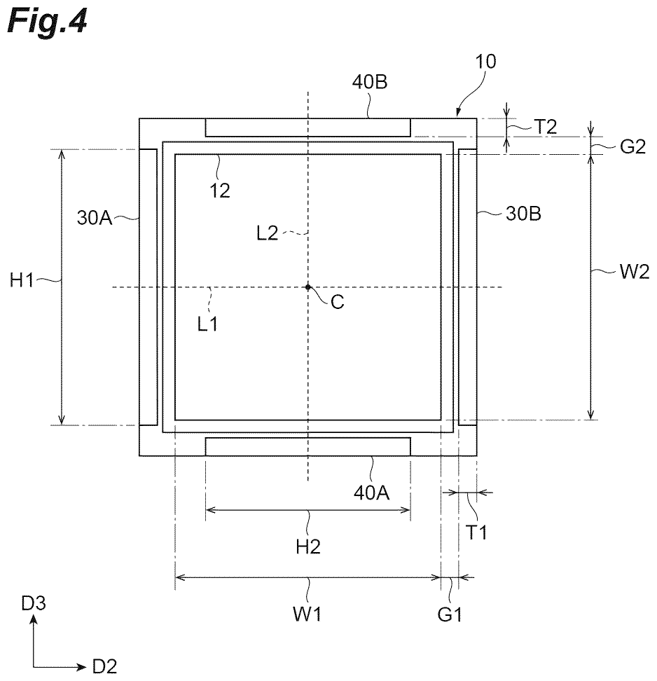

The yoke 20 is arranged around the opening 12 of the main body 10 in a cross-section orthogonal to the first direction D1, as shown in FIG. 4. As shown in FIG. 3, in present embodiment, the yoke 20 includes four yoke portions 30A and 30B, 40A, and 40B, and each of the yoke portions 30A and 30B, 40A, and 40B has a flat plate shape extending over the entire length of the surrounding portion 16 in the first direction D1 and is embedded in the surrounding portion 16.

The yoke portions 30A and 30B constitute a pair of first yoke portions and are arranged to face each other in the second direction D2. The first yoke portions 30A and 30B can be made of, for example, carbon steel, iron, or die steel (alloy tool steel). In present embodiment, the first yoke portions 30A and 30B have substantially the same cross-sectional dimensions and cross-sectional shape, and have a rectangular cross-section with the long side parallel to the third direction D3. As shown in FIG. 4, the pair of first yoke portions 30A and 30B are arranged symmetrically with respect to a reference line L1 (a second reference line) that sandwiches the opening 12 with respect to the second direction D2 and extends in the second direction D2 through the center C of the opening 12, in a cross-section orthogonal to the first direction D1. Specifically, in a cross-section orthogonal to the first direction D1, the center of each of the pair of first yoke portions 30A and 30B with respect to the third direction D3 is located on the reference line L1. In present embodiment, both of the first yoke portions 30A and 30B are designed such that, in a cross-section orthogonal to the first direction D1, their length in the third direction D3 is longer than the length of the side of the opening 12 extending in the third direction D3, and both end portions in the third direction D3 protrude from the opening 12. When a magnetic field along the second direction D2 is applied to the pressing mold 1, as in the method for making a sintered magnet described later, the magnetic flux along the second direction D2 is strengthened by the magnetization of the first yoke portions 30A and 30B, which face each other in the magnetic field application direction.

The yoke portions 40A and 40B constitute a pair of second yoke portions and are arranged to face each other in the third direction D3. The second yoke portions 40A and 40B can be made of, for example, carbon steel, iron, or die steel (alloy tool steel), and the constituent material may be the same as or different from that of the first yoke portions 30A and 30B. In present embodiment, the yoke portions 40A and 40B have substantially the same cross-sectional dimensions and cross-sectional shape, and have a rectangular cross-section with the long side parallel to the second direction D2. As shown in FIG. 4, the pair of second yoke portions 40A and 40B are arranged symmetrically with respect to a reference line L2 (a first reference line) that sandwiches the opening 12 with respect to the third direction D3 and extends in the third direction D3 through the center C of the opening 12, in a cross-section orthogonal to the first direction D1. Specifically, in a cross-section orthogonal to the first direction D1, the center of each of the pair of second yoke portions 40A and 40B with respect to the second direction D2 is located on the reference line L2. The pair of second yoke portions 40A and 40B are also arranged symmetrically with respect to the reference line L1 in a cross-section orthogonal to the first direction D1. Specifically, in a cross-section orthogonal to the first direction D1, the pair of second yoke portions 40A and 40B face each other with the reference line L1 interposed therebetween. In a cross-section orthogonal to the first direction D1, the area occupied by the second yoke portions 40A and 40B can be designed to be smaller than the area occupied by the first yoke portions 30A and 30B. When a magnetic field along the second direction D2 is applied to the pressing mold 1, as in the method for making a sintered magnet described later, the magnetic flux in the vicinity thereof is regulated by the second yoke portions 40A and 40B.

In present embodiment, with respect to the second direction D2, a ratio (G1/W1) of a separation distance G1 between the first yoke portions 30A and 30B and the opening 12 to a length W1 of the opening 12 is 0.01 or more and 3 or less, and as an example, the ratio G1/W1 is 0.24. Also, with respect to the third direction D3, a ratio (G2/W2) of a separation distance G2 between the second yoke portions 40A and 40B and the opening 12 to a length W2 of the opening 12 is 0.05 or more and 3 or less, and as an example, is 0.41.

Also, in present embodiment, with respect to the third direction D3, a ratio (T2/W2) of a length T2 of the second yoke portions 40A and 40B to the length W2 of the opening 12 is 0.01 or more and 0.5 or less, and as an example, is 0.17. Also, with respect to the second direction D2, a ratio (H2/W1) of a length H2 of the second yoke portions 40A and 40B to the length W1 of the opening 12 is 0.01 or more and 0.8 or less, and as an example, is 0.04.

Furthermore, in present embodiment, with respect to the third direction D3, a ratio (T2/H1) of the length T2 of the second yoke portions 40A and 40B to a length H1 of the first yoke portions 30A and 30B is 0.01 or more and 1 or less, and as an example, is 0.17. Also, with respect to the second direction D2, a ratio (H2/T1) of the length H2 of the second yoke portions 40A and 40B to a length T1 of the first yoke portions 30A and 30B is 0.05 or more and 12 or less, and as an example, is 0.36.

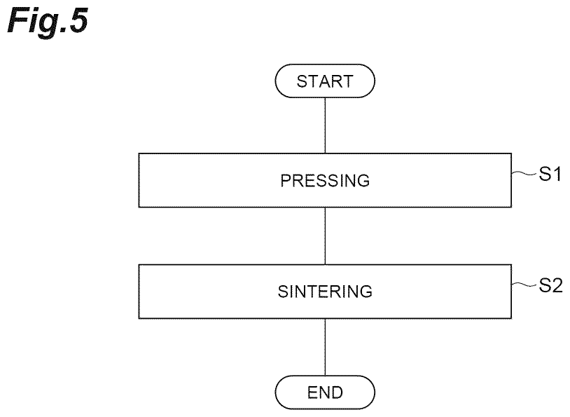

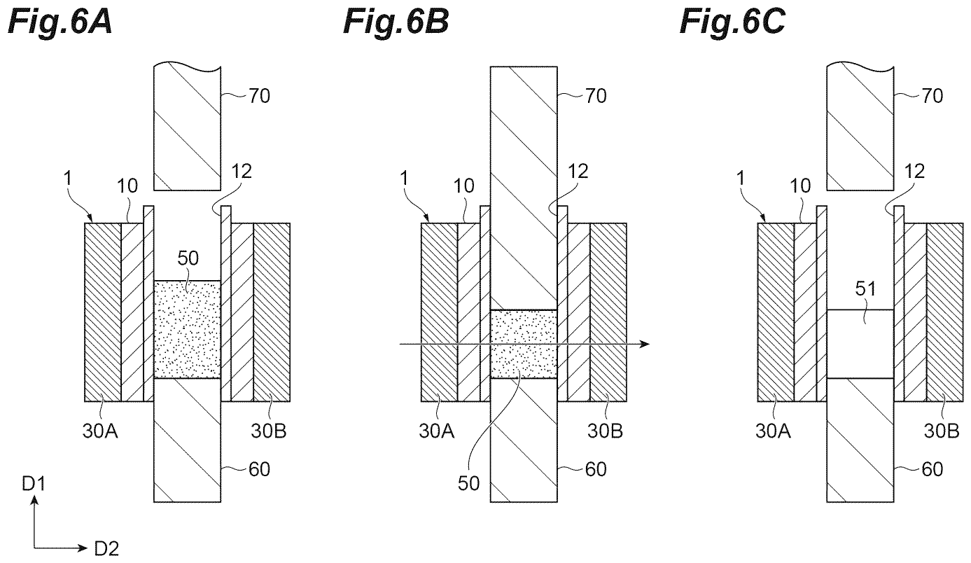

Next, a procedure for forming a sintered magnet using the above-described pressing mold 1 will be described with reference to FIGS. 5, 6A, 6B, and 6C.

When forming a sintered magnet, first, magnetic powder that will become the sintered magnet is prepared. The magnetic powder can be obtained by a known method, and is obtained, for example, by pulverizing a raw material alloy. The pulverization step may be performed in two stages or in one stage. There is no particular limitation on the method of pulverization. For example, it is performed by a method using various pulverizers. For example, the pulverization step is performed in two stages, a coarse pulverization step and a fine pulverization step, and the coarse pulverization step can be, for example, hydrogen decrepitation pulverization. Hydrogen decrepitation pulverization can be performed by causing self-disintegration pulverization by releasing hydrogen based on the difference in the amount of hydrogen absorbed between different phases after causing a main phase alloy to absorb hydrogen. Releasing hydrogen based on the difference in the amount of hydrogen absorbed between different phases is called dehydrogenation. There are no particular restrictions on the conditions for dehydrogenation, but for example, dehydrogenation is performed at 300 to 650° C. in an argon flow or in a vacuum. The fine pulverization step can be performed on the powder after coarse pulverization, for example, by adding a lubricant such as oleic acid amide, lauric acid amide, or zinc stearate as a pulverization aid, and then using, for example, a jet mill, a wet attritor, or the like. There is no particular restriction on the particle size of the obtained fine powder (raw material powder). For example, fine pulverization can be performed so that the raw material powder has a particle size (D50) of 1 μm or more and 10 μm or less.

Then, the above magnetic powder is molded by pressing (step S1 in FIG. 5). When the magnetic powder is a rare-earth magnet material, a rare-earth magnet is obtained, and when the magnetic powder is ferrite, a ferrite magnet is obtained. The press-molding in step S1 is performed, for example, by the procedures shown in FIGS. 6A, 6B, and 6C. FIG. 6A shows a state where magnetic powder 50 is filled in the opening 12 of the pressing mold 1. At this time, the lower opening of the opening 12 is closed by a lower punch 60. When an upper punch 70 descends and the upper opening of the opening 12 is closed, as shown in FIG. 6B, a magnetic field along the second direction D2 is applied to the pressing mold 1, and the magnetic powder 50 is oriented along the direction of the magnetic field. Then, in a state where the magnetic field is applied, the upper punch 70 further descends, and the magnetic powder 50 filled in the opening 12 is pressed with respect to the first direction D1 between the upper punch 70 and the lower punch 60. This press-molding is so-called perpendicular magnetic field molding because the pressing direction D1 and the magnetic field application direction D2 are in a perpendicular relationship. The upper punch 70 and the lower punch 60 can be made of, for example, a magnetic material, and can be made of a cemented carbide or carbon steel, which corresponds to a soft magnetic material. When the press-molding is finished, the application of the magnetic field is cut off, and demagnetization is performed by an alternating magnetic field. As a result, as shown in FIG. 6C, a green compact 51 of the magnetic powder oriented in the second direction D2 is formed.

In the pressing step S1, pressurization may be performed at 30 MPa or more and 300 MPa or less. The applied magnetic field may be 950 kA/m or more and 1600 kA/m or less. The applied magnetic field is not limited to a static magnetic field, and can also be a pulse magnetic field. It is also possible to use a static magnetic field and a pulse magnetic field in combination.

Then, by sintering the green compact 51 taken out from the pressing mold 1 under known sintering conditions, a sintered body oriented in the second direction D2 is formed (step S2 in FIG. 5). By magnetizing the sintered body along the second direction D2 by a known method, a sintered magnet 52 magnetized in the second direction D2 can be obtained.

The sintering step S2 is a step of obtaining a sintered body by sintering the green compact 51 in a vacuum or an inert gas atmosphere. The sintering temperature needs to be adjusted according to various conditions such as composition, pulverization method, and differences in particle size and particle size distribution, but the green compact is sintered, for example, by performing a treatment of heating in a vacuum or in the presence of an inert gas at 1000° C. or more and 1200° C. or less for 1 hour or more and 10 hours or less. This provides a high-density sintered body. The steps from hydrogen decrepitation pulverization to the sintering step can always be performed in a low-oxygen atmosphere with an oxygen concentration of less than 230 ppm.

The aging treatment step is performed by heating the sintered body after the sintering step in a vacuum or an inert gas atmosphere at a temperature lower than the sintering temperature. There are no particular restrictions on the temperature and time of the aging treatment, but it can be performed, for example, at 450° C. or more and 900° C. or less for 0.2 hours or more and 3 hours or less. This aging treatment step may be omitted.

The aging treatment step may be a single stage, or may be performed in two stages. When performed in two stages, for example, the first stage may be at 700° C. or more and 900° C. or less for 0.2 hours or more and 3 hours or less, and the second stage may be at 450° C. or more and 700° C. or less for 0.2 hours or more and 3 hours or less. The first stage and the second stage may be performed continuously, or after the first stage, the workpiece may be cooled to near room temperature and then reheated to perform the second stage.

A diffusion treatment for diffusing a heavy rare-earth element from the outside to the inside of the sintered body may be performed on the obtained sintered body. There is no particular limitation on the method of the diffusion treatment. For example, it may be a coating diffusion method in which powder or foil containing a heavy rare-earth element is brought into close contact with the sintered body and heat treatment is performed, or it may be a vapor phase diffusion method in which heat treatment is performed on the sintered body in an atmosphere in which a heavy rare-earth element is vaporized.

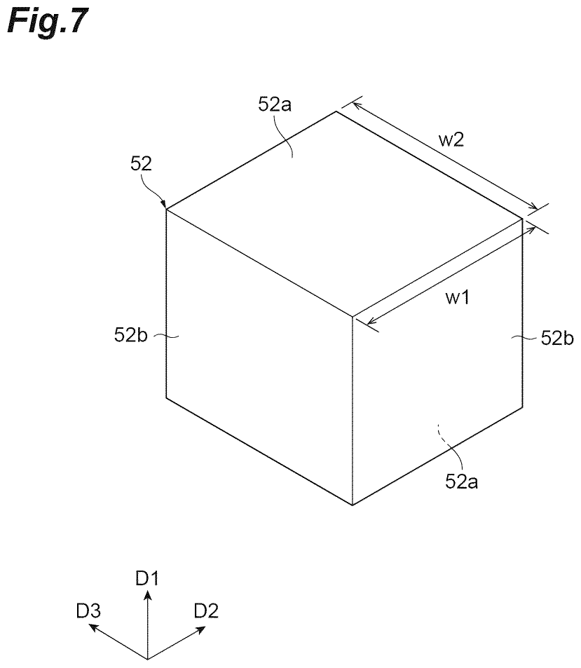

As shown in FIG. 7, the sintered magnet 52 has a rectangular parallelepiped outer shape. Specifically, the sintered magnet 52 has a pair of main surfaces 52a facing each other in the first direction D1, which is the pressing direction, and has four side surfaces 52b connecting the pair of main surfaces 52a. The sintered magnet 52 has a length w1 with respect to the second direction D2, and a length w2 with respect to the third direction D3. The dimensions of the sintered magnet 52 (i.e., w1×w2) are smaller than the dimensions of the opening 12 (W1×W2), which is due to the thermal shrinkage of the green compact 51 during sintering. For example, the shrinkage rate (1−w1/W1) with respect to the second direction D2 is 20 to 40%, and the shrinkage rate (1−w2/W2) with respect to the third direction D3 is 5 to 32%. The shrinkage rate with respect to the third direction D3 may be lower than the shrinkage rate with respect to the second direction D2. For example, when the W1 dimension of the opening 12 is 60 mm and the W2 dimension is 60 mm, the w1 dimension of the sintered magnet 52 can be 42 mm and the w2 dimension can be 54 mm. When the W1 dimension of the opening 12 is 120 mm and the W2 dimension is 80 mm, the w1 dimension of the sintered magnet 52 can be 84 mm and the w2 dimension can be 72 mm. The length (i.e., thickness) of the sintered magnet 52 with respect to the first direction D1 can be appropriately selected according to the application.

The sintered magnet 52 may be used with its as-sintered dimensions, or may be appropriately cut and used depending on the application. When used with its as-sintered dimensions, the surface of the sintered magnet 52 (i.e., the main surfaces 52a and the side surfaces 52b) will be an as-sintered surface, and when used after being cut, at least a part of the surface of the sintered magnet 52 will be a cut surface. The surface of the sintered magnet 52 may be subjected to surface processing such as polishing or coating as necessary.

The inventors have found that when the sintered magnet 52 is formed using perpendicular magnetic field molding, the orientation is locally disturbed. Such a disturbance in orientation can be confirmed by the variation in the degree of orientation with respect to the second direction D2 in the entire region of the sintered magnet 52 when viewed from the first direction D1. For the calculation of the degree of orientation, a known calculation method can be used, and for example, it is obtained as a percentage value from the Lotgering method using X-ray diffraction. In the Lotgering method, specifically, after mirror-polishing the magnetic pole face of the sintered magnet 52, an X-ray diffraction measurement is performed on the mirror-polished face. Then, the degree of orientation is calculated based on the diffraction peaks obtained by the X-ray diffraction measurement. The degree of orientation is calculated as a percentage value of the quotient obtained by dividing the integrated value ΣI(00l) of the X-ray diffraction intensity I(00l) of the (00l) reflection component by the integrated value ΣI(hkl) of the X-ray diffraction intensity I(hkl) of the (hkl) reflection component. When calculating the degree of orientation by the Lotgering method, the accuracy can be improved by performing vector correction on the X-ray diffraction intensity of each diffraction peak. That is, when calculating the degree of orientation by the Lotgering method, if only the components of perfect (00l) reflection are integrated, the calculated degree of orientation can be a considerably small value. Therefore, by also integrating components that can be regarded as (00l) reflection by vector correction, a degree of orientation that is more in line with the actual situation can be obtained. In the vector correction, a diffraction peak whose orientation is different from the reflection X-ray of the (00l) plane is separated into a reflection component of the (00l) plane and a reflection component of the (hk0) plane orthogonal thereto. The separated reflection component of the (00l) plane is added to the integrated value ΣI(00l). For example, when the plane orientation of a certain crystal plane X is different from (00l), the diffraction peak corresponding to the plane orientation of the crystal plane X is multiplied by cosα based on the inclination angle α of the diffraction peak. By this multiplication, the reflection component of the (00l) plane among the reflection components of the crystal plane X is calculated. The reflection component of (00l) calculated from this reflection component of the crystal plane X is integrated into the integrated value ΣI(00l). The variation in the degree of orientation is obtained from the variation in the degree of orientation between the section having the maximum degree of orientation and the section having the minimum degree of orientation with respect to the second direction D2.

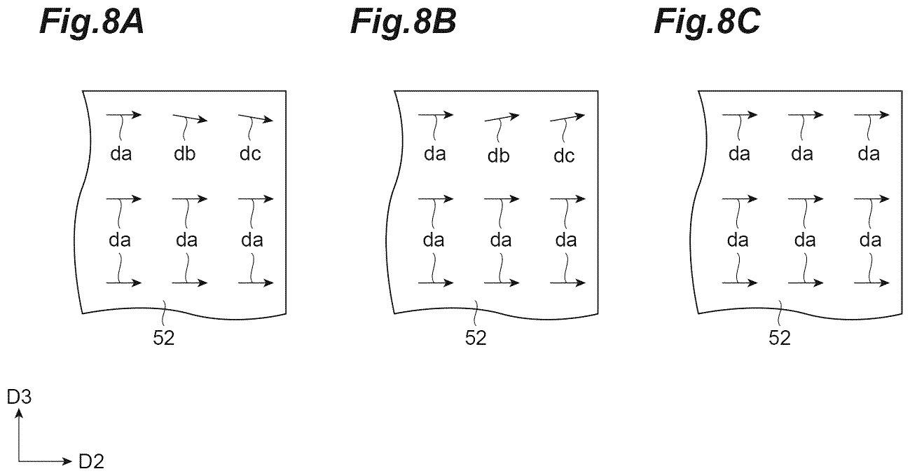

Each of FIGS. 8A, 8B, and 8C shows an enlarged view of the portion located at the end with respect to the third direction D3 during press-molding, as seen from the first direction D1. In FIGS. 8A, 8B, and 8C, the orientations (da, db, dc) at nine sites are shown. The orientation da has a degree of orientation of substantially 100%, and its direction substantially coincides with the second direction D2. The orientation db has a degree of orientation lower than 100% but relatively high, and its direction is slightly deviated from the second direction D2. The orientation dc has a degree of orientation lower than the orientation db, and its direction is further deviated from the second direction D2 compared to the orientation db. Therefore, in FIGS. 8A, 8B, and 8C, the section with orientation da has the maximum degree of orientation, and the section with orientation dc has the minimum degree of orientation. In this case, regarding the variation in the degree of orientation, the aspects of FIG. 8A and FIG. 8B have the same variation in the degree of orientation (da-dc), and in the aspect of FIG. 8C, there is no variation in the degree of orientation (variation in the degree of orientation=0).

As an aspect in which the orientation is locally disturbed in the sintered magnet 52, it is conceivable that the orientation is directed away from the end surface in the vicinity of the end surface with respect to the third direction D3, as in the orientations db and dc of FIG. 8A, or that the orientation is directed toward the end surface in the vicinity of the end surface with respect to the third direction D3, as in the orientations db and dc of FIG. 8B. This is considered to be because the magnetic field distribution becomes non-uniform at the end portion with respect to the third direction D3 when the magnetic powder 50 filled in the opening 12 is pressed in the first direction D1 while applying a magnetic field along the second direction D2. The magnetic field distribution is determined according to the magnetic pole size of a pair of electromagnet coils for generating a magnetic field, which face each other so as to sandwich the pressing mold 1 in the second direction D2, the distance between the magnetic poles, and the like. The pair of electromagnet coils are both wound, for example, around a common center line that overlaps with the reference line L1 when viewed from the first direction D1. In this case, the magnetic flux in the pressing mold 1 due to the pair of electromagnet coils is substantially parallel to the second direction D2 near the center line, but bulges outward (i.e., toward the third direction D3 side) such that the curvature increases with distance from the center line. Therefore, in the vicinity of the end portion of the opening 12 with respect to the third direction D3, the magnetic flux is inclined with respect to the second direction D2, so that the magnetic field distribution is likely to become non-uniform.

The above-described pressing mold 1 is provided with the pair of second yoke portions 40A and 40B, and the magnetic flux of the magnetic field applied during press-molding can be adjusted by the pair of second yoke portions 40A and 40B. That is, since the second yoke portions 40A and 40B attract the surrounding magnetic flux, deviations such as the orientations db and dc associated with the local disturbance of the magnetic flux shown in FIGS. 8A and 8B are corrected, and as a result, it is possible to approach an ideal magnetic field orientation that is generally along the magnetization direction, as in the orientation da shown in FIG. 8C. By making the magnetic field distribution uniform in this way, high magnetic properties of the sintered magnet 52 obtained by the pressing mold 1 can be realized. When the magnetic field distribution is made uniform by the second yoke portions 40A and 40B, the yoke portions 30A and 30B are magnetized in a direction generally along the magnetization direction. With the above configuration, the magnetic field distribution is made uniform and strengthened, whereby high magnetic properties of the sintered magnet 52 obtained by the pressing mold 1 can be realized.

In the above-described pressing mold 1, in the cross-section orthogonal to the first direction D1, both end portions of the first yoke portions 30A and 30B with respect to the third direction D3 protrude from the opening 12, whereby the disturbance of the magnetic field orientation at the end portions and corner portions of the opening 12 is significantly suppressed. In the vicinity of both end portions of the first yoke portions 30A and 30B with respect to the third direction D3, the above-mentioned outward bulging of the magnetic flux tends to be large, but since both end portions protrude from the opening 12, the outward bulging of the magnetic flux within the opening 12 is suppressed, and further uniformization of the magnetic field distribution can be achieved.

In the above-described pressing mold 1, with respect to the second direction D2, the ratio (G1/W1) of the separation distance G1 between the first yoke portions 30A and 30B and the opening 12 to the length W1 of the opening 12 is 3 or less. If the ratio G1/W1 exceeds 3, the magnetic flux in the opening 12 becomes weak because the first yoke portions 30A and 30B and the opening 12 are too far apart, and the degree of orientation of the sintered magnet 52 as a whole decreases, but if the ratio G1/W1 is 3 or less, the first yoke portions 30A and 30B and the opening 12 are not too far apart, so the magnetic flux of the magnetic field applied during press-molding is easily regulated, and further uniformization of the magnetic field distribution is achieved. If the ratio G1/W1 is less than 0.01, the surrounding portion 16 interposed between the first yoke portions 30A and 30B and the opening 12 becomes thin, making it difficult to secure sufficient strength. In the above-described pressing mold 1, with respect to the third direction D3, the ratio (G2/W2) of the separation distance G2 between the second yoke portions 40A and 40B and the opening 12 to the length W2 of the opening 12 is 3 or less. If the ratio G2/W2 exceeds 3, the length (thickness) of the surrounding portion 16 holding the second yoke portions 40A and 40B with respect to the third direction D3 becomes long, leading to an increase in costs such as material costs, and the effect of rectification becomes small relative to the manufacturing cost of the pressing mold 1. If the ratio G2/W2 is 3 or less, the second yoke portions 40A and 40B and the opening 12 are not too far apart, so the magnetic flux of the magnetic field applied during press-molding is easily regulated, and further uniformization of the magnetic field distribution is achieved. If the ratio G2/W2 is less than 0.05, the surrounding portion 16 interposed between the second yoke portions 40A and 40B and the opening 12 becomes thin, making it difficult to secure sufficient strength.

In the above-described pressing mold 1, with respect to the third direction D3, the ratio (T2/W2) of the length T2 of the second yoke portions 40A and 40B to the length W2 of the opening 12 is 0.01 or more, and by securing a sufficient length (thickness) of the second yoke portions 40A and 40B, the magnetic flux of the magnetic field applied during press-molding is easily regulated, and further uniformization of the magnetic field distribution is achieved. If the ratio T2/W2 exceeds 0.5, the length (thickness) of the second yoke portions 40A and 40B becomes long, and accordingly, the length (thickness) of the surrounding portion 16 holding the second yoke portions 40A and 40B with respect to the third direction D3 also becomes long, leading to an increase in costs such as material costs, and the effect of rectification becomes small relative to the manufacturing cost of the pressing mold 1. In the above-described pressing mold 1, with respect to the second direction D2, the ratio (H2/W1) of the length H2 of the second yoke portions 40A and 40B to the length W1 of the opening 12 is 0.01 or more, and by securing a sufficient length of the second yoke portions 40A and 40B, the magnetic flux of the magnetic field applied during press-molding is easily regulated, and further uniformization of the magnetic field distribution is achieved. If the ratio H2/W1 exceeds 0.8, the magnetic flux concentrates in the second yoke portions 40A and 40B, whereby the magnetic flux in the opening 12 becomes weak, and the degree of orientation of the sintered magnet 52 as a whole decreases.

In the above-described pressing mold 1, with respect to the third direction D3, the ratio (T2/H1) of the length T2 of the second yoke portions 40A and 40B to the length H1 of the first yoke portions 30A and 30B is 0.01 or more, and by securing a sufficient length (thickness) of the second yoke portions 40A and 40B, the magnetic flux of the magnetic field applied during press-molding is easily regulated, and further uniformization of the magnetic field distribution is achieved. If the ratio T2/H1 exceeds 0.5, the length (thickness) of the second yoke portions 40A and 40B becomes long, and accordingly, the length (thickness) of the surrounding portion 16 holding the second yoke portions 40A and 40B with respect to the third direction D3 also becomes long, leading to an increase in costs such as material costs, and the effect of rectification becomes small relative to the manufacturing cost of the pressing mold 1. In the above-described pressing mold 1, with respect to the second direction D2, the ratio (H2/T1) of the length H2 of the second yoke portions 40A and 40B to the length T1 of the first yoke portions 30A and 30B is 0.05 or more, and by securing a sufficient length of the second yoke portions 40A and 40B, the magnetic flux of the magnetic field applied during press-molding is easily regulated, and further uniformization of the magnetic field distribution is achieved. If the ratio H2/T1 exceeds 12, the magnetic flux concentrates in the second yoke portions 40A and 40B, whereby the magnetic flux in the opening 12 becomes weak, and the degree of orientation of the sintered magnet 52 as a whole decreases. If the ratio H2/T1 is 12 or less, the magnetic flux tends to concentrate in the opening 12, and if the ratio H2/T1 is 8 or less, the magnetic flux tends to concentrate further in the opening 12, thereby increasing the degree of orientation of the sintered magnet 52 as a whole.

In the above-described embodiment, each of the second yoke portions 40A and 40B is composed of a single yoke member, but it may be composed of a plurality of yoke members. The relative positions of the plurality of yoke members with respect to the opening 12 can be appropriately changed in design.

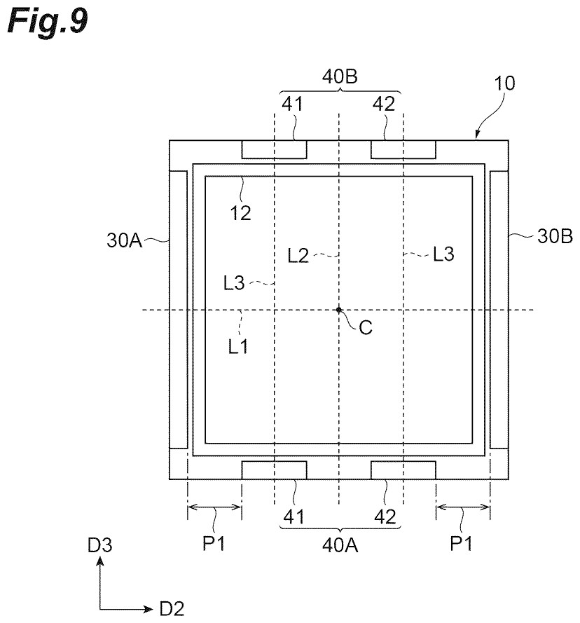

For example, as shown in FIG. 9, each of the second yoke portions 40A and 40B may be composed of two yoke members 41 and 42 sandwiching the reference line L2. Even when composed of two yoke members 41 and 42, the pair of second yoke portions 40A and 40B are arranged symmetrically with respect to the reference line L2 in a cross-section orthogonal to the first direction D1. The yoke member 41 constituting the second yoke portion 40A and the yoke member 41 constituting the second yoke portion 40B are arranged at positions facing each other in the third direction D3, and the yoke member 42 constituting the second yoke portion 40A and the yoke member 42 constituting the second yoke portion 40B are also arranged at positions facing each other in the third direction D3. More specifically, the center of each of the yoke members 41 and 42 with respect to the second direction D2 is located on a line L3 that divides the opening 12 into four equal parts with respect to the second direction D2.

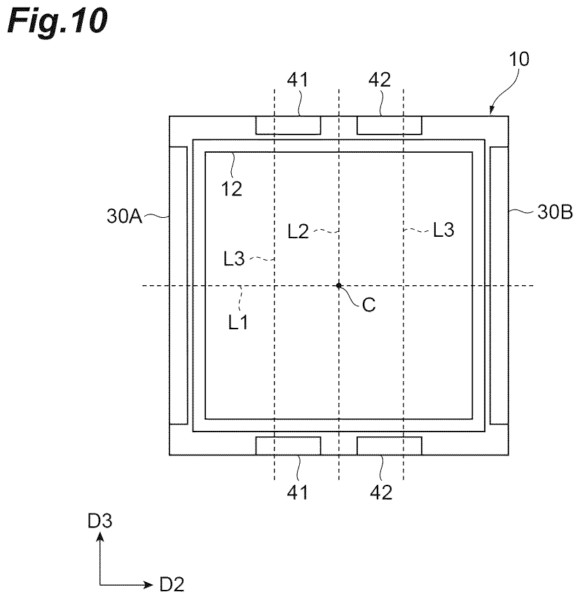

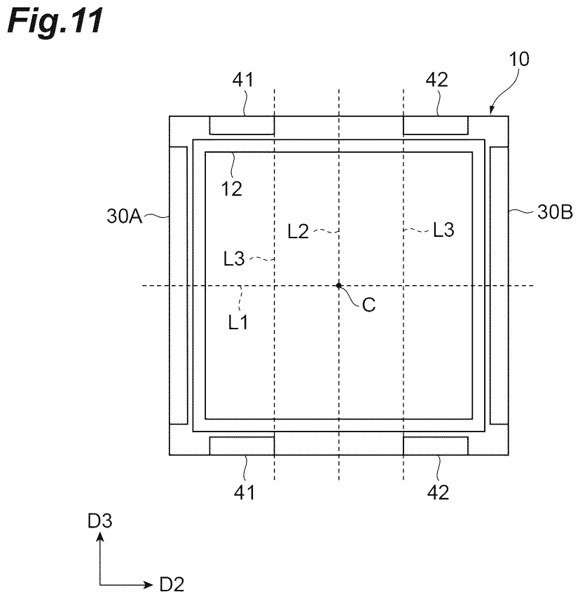

The yoke members 41 and 42 may be biased toward the reference line L2 side such that their centers with respect to the second direction D2 approach the reference line L2, as shown in FIG. 10. In this case, the disturbance of the magnetic flux generated in the vicinity of the reference line L2 is regulated. The yoke members 41 and 42 may be biased to the side opposite to the reference line L2 such that their centers with respect to the second direction D2 move away from the reference line L2, as shown in FIG. 11. In this case, the disturbance of the magnetic flux generated at the corners of the sintered magnet 52 away from the reference line L2 is regulated. Since both end portions of the yoke members 41 and 42 with respect to the second direction D2 do not protrude from the opening 12, the disturbance of the magnetic flux of the magnetic field applied to the opening 12 can be efficiently regulated. In addition, since both end portions of the yoke members 41 and 42 with respect to the second direction D2 do not protrude from the opening 12, it is possible to suppress a large amount of magnetic flux from flowing out from the pressing mold 1 toward the side surfaces of the pressing mold 1 (more specifically, the surrounding portion 16) with respect to the second direction D2, so that the magnetic field applied to the opening 12 can be strengthened.

In the above-described embodiment, an aspect was shown in which the pair of second yoke portions 40A and 40B completely face each other in the third direction D3 in a cross-section orthogonal to the first direction D1, but as long as they sandwich the opening 12 with respect to the third direction D3, the second yoke portions 40A and 40B may be in an aspect of partially facing each other. In a cross-section orthogonal to the first direction D1, the pair of second yoke portions 40A and 40B may be arranged asymmetrically with respect to the reference line L2. The second yoke portions 40A and 40B may have different cross-sectional dimensions and cross-sectional shapes from each other, and the yoke members 41 and 42 constituting the second yoke portions 40A and 40B may also have different cross-sectional dimensions and cross-sectional shapes from each other.

The present disclosure is not limited to the above-described embodiments and can be variously modified. For example, the first yoke portions 30A and 30B and the second yoke portions 40A and 40B may be configured as separate bodies or may be configured integrally. The yoke portions 30A, 30B, 40A, and 40B do not necessarily need to be embedded in the surrounding portion 16, and may be, for example, in an aspect of being attached to the surface of the surrounding portion 16. The yoke portions 30A, 30B, 40A, and 40B may be shorter than the full length of the surrounding portion 16 in the first direction D1. The pair of second yoke portions 40A and 40B may or may not sandwich the opening 12 with respect to the third direction D3. Furthermore, the opening 12 provided in the pressing mold 1 may be in an aspect of being partitioned into a plurality of sections (for example, into two equal parts) by a partition wall extending in the second direction D2 or a partition wall extending in the third direction D3, when viewed from the first direction D1.

### EXAMPLES

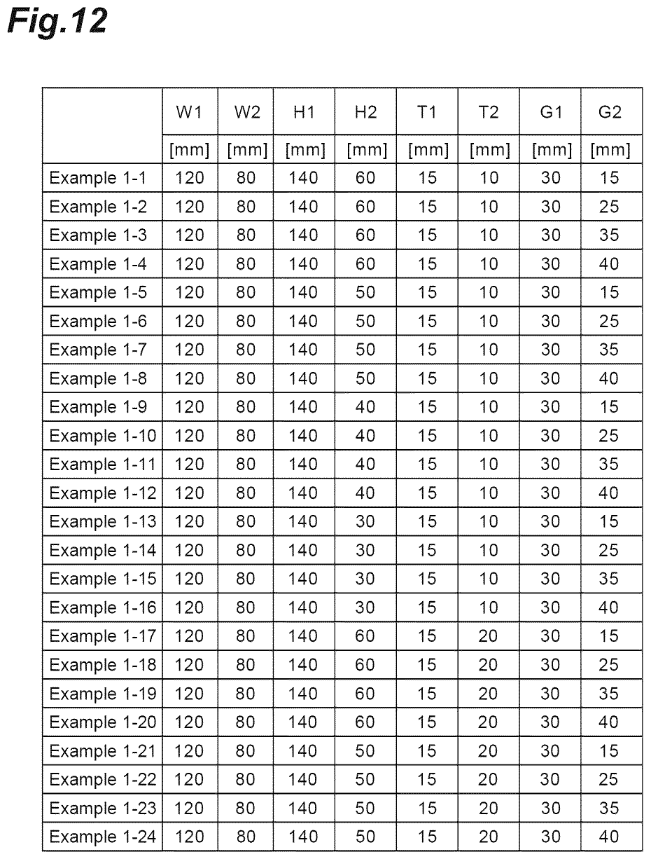

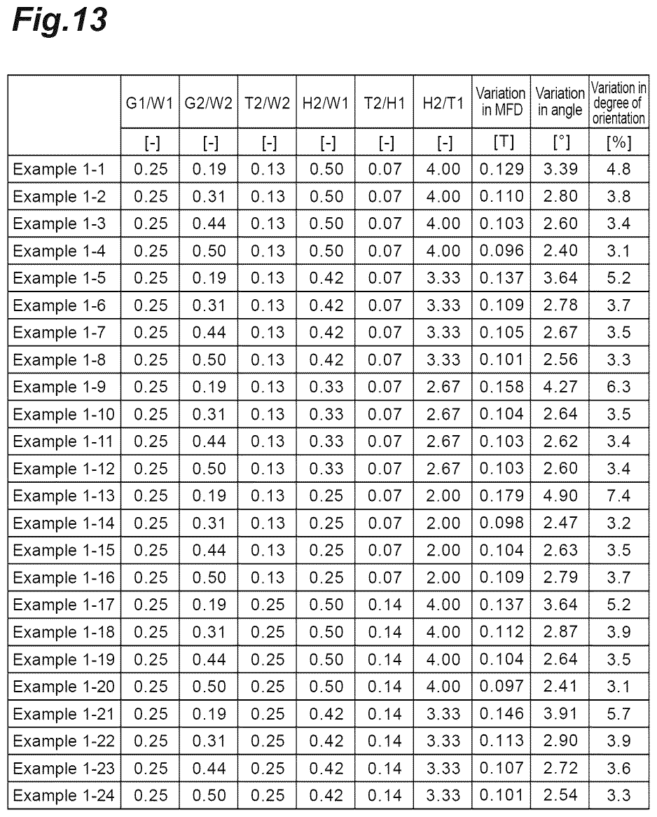

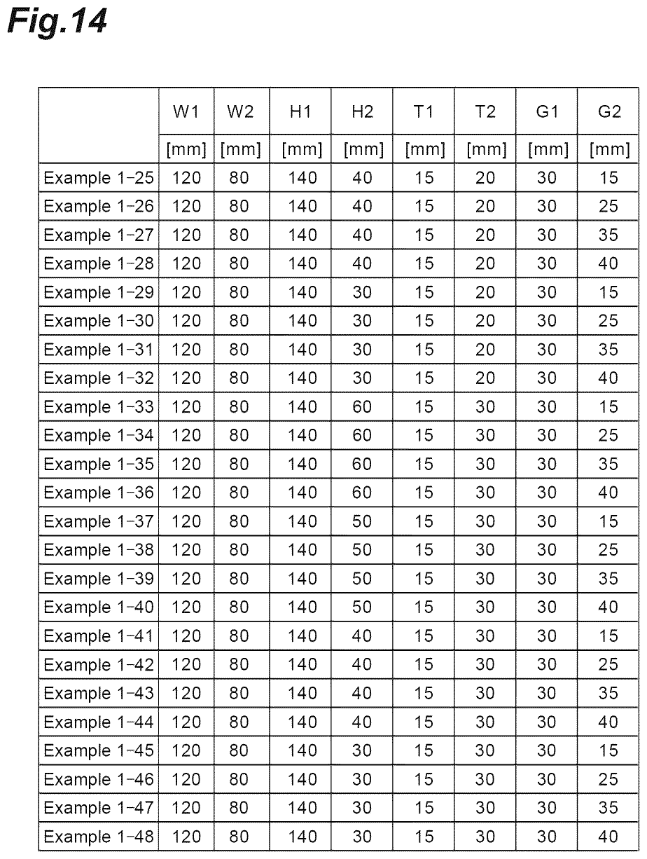

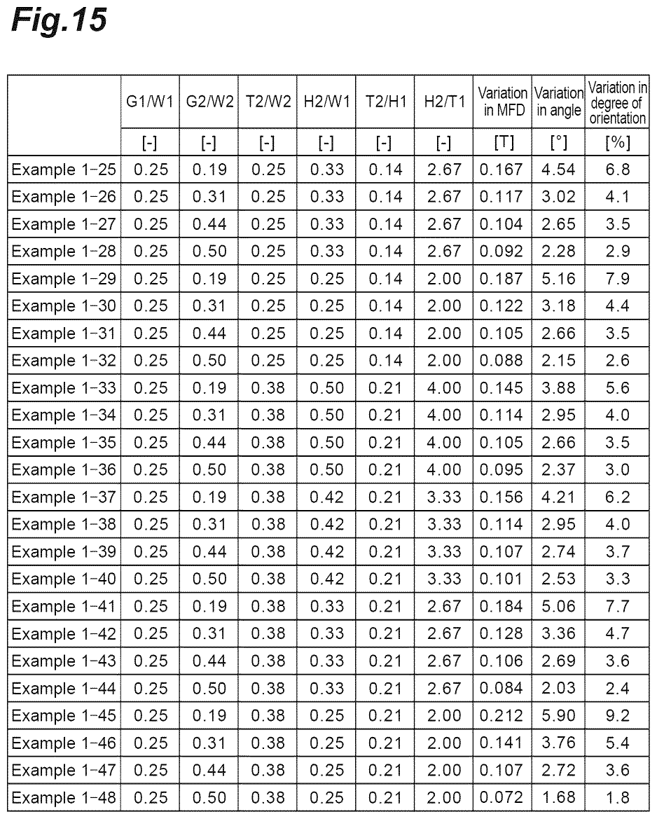

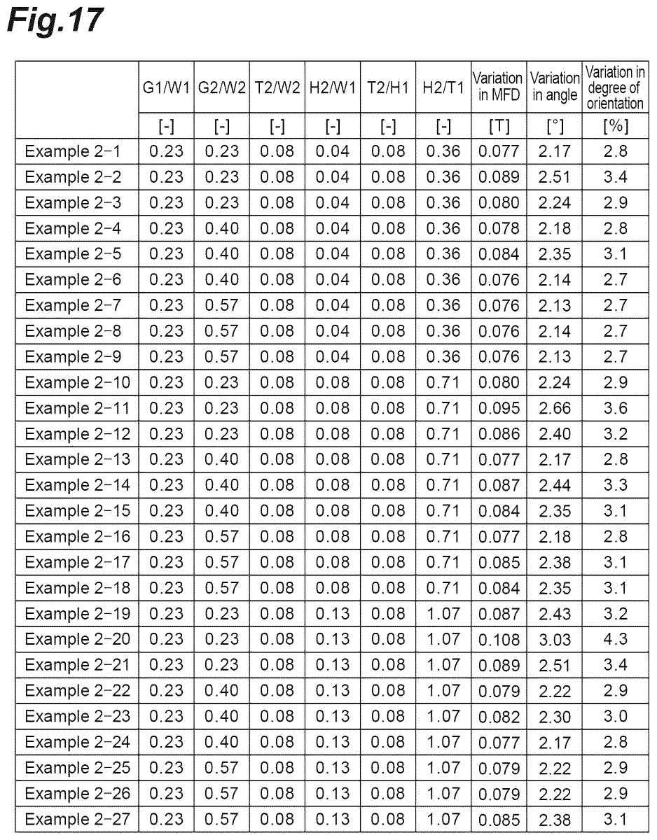

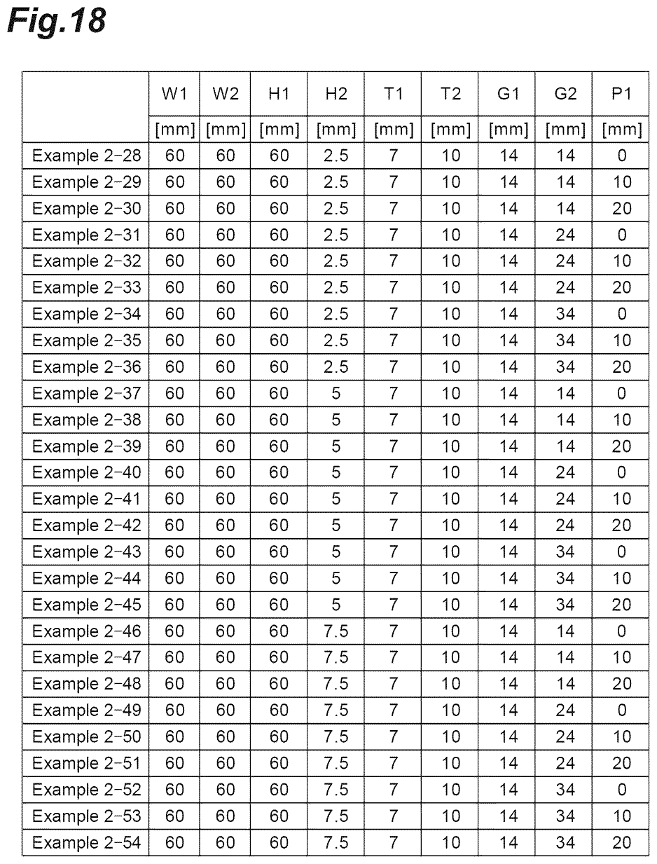

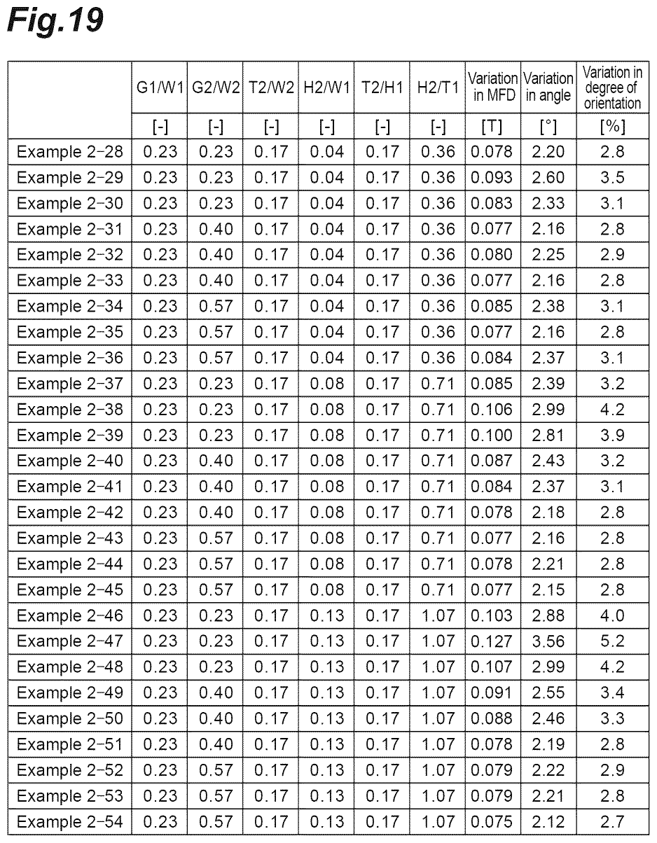

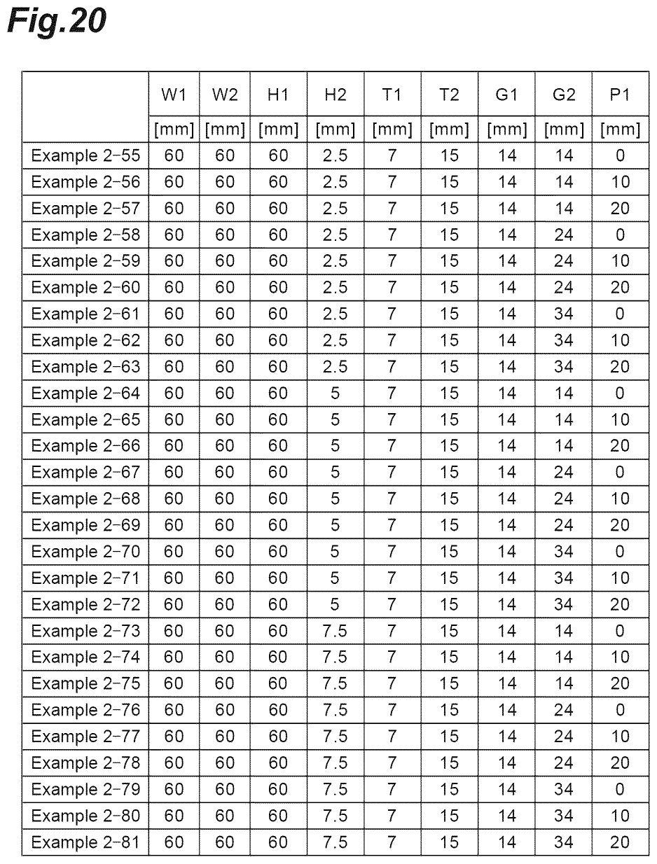

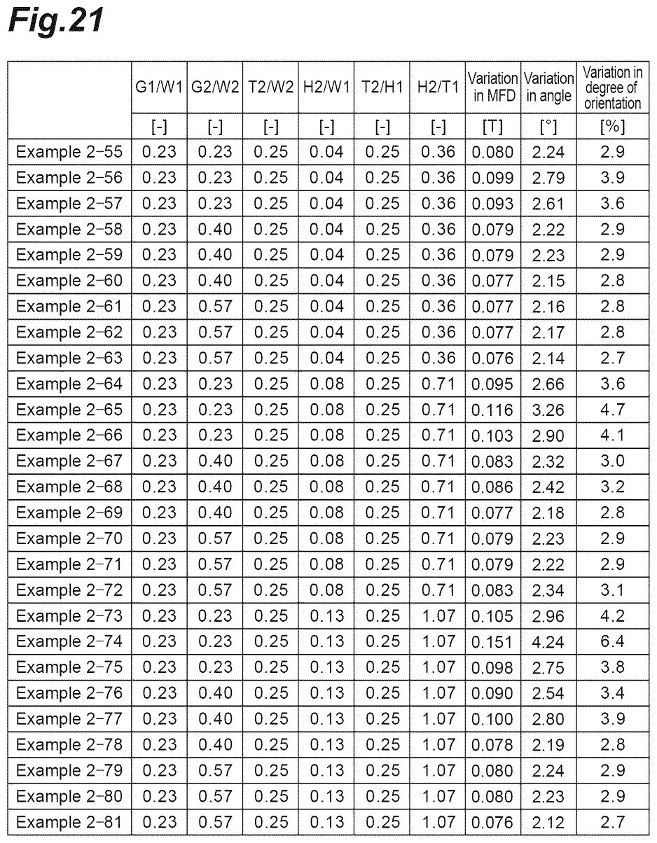

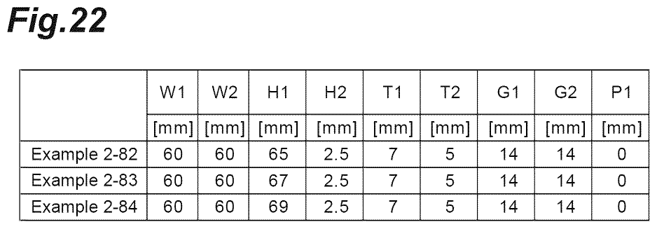

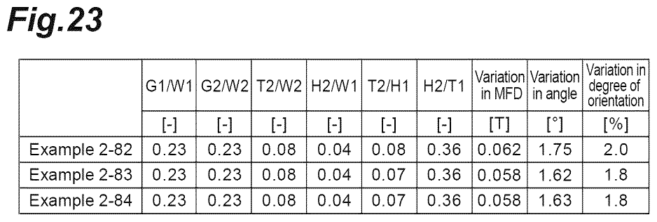

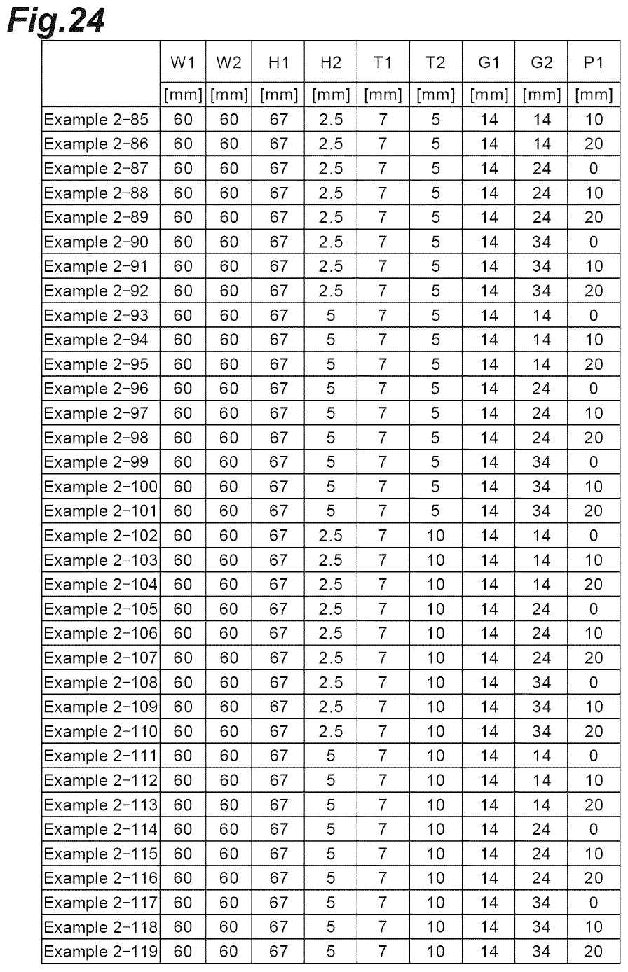

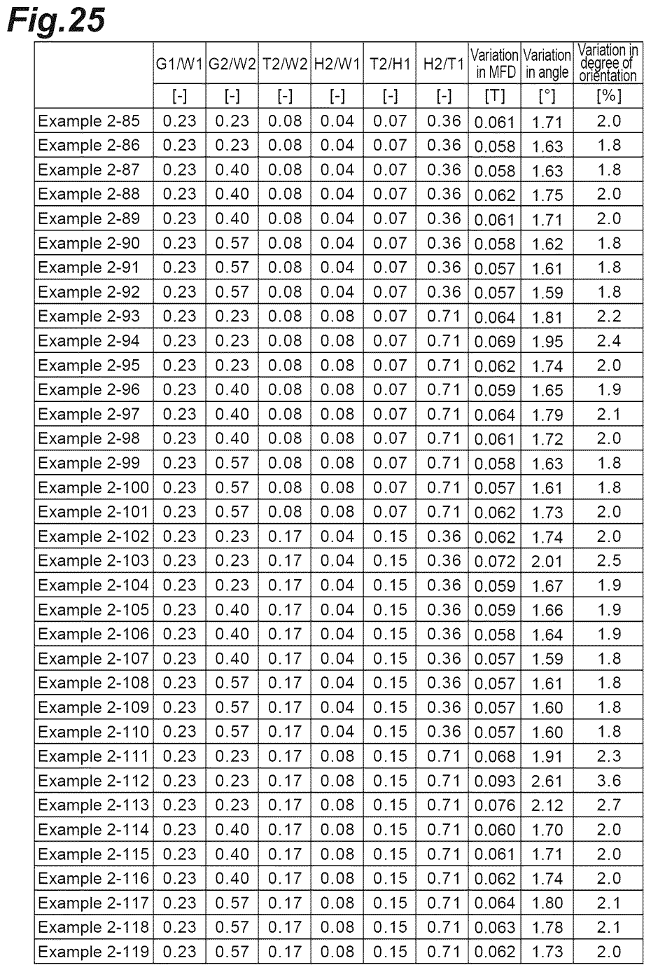

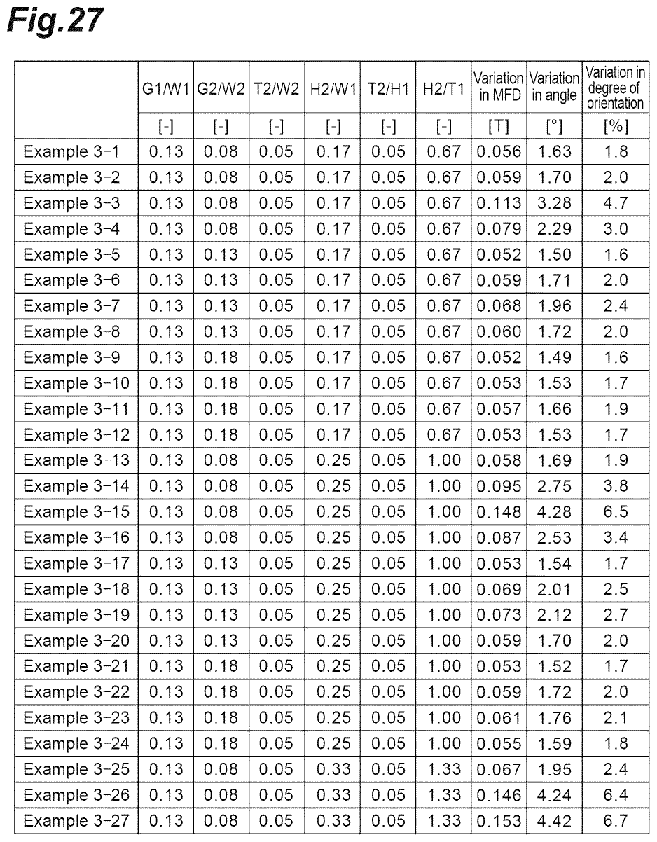

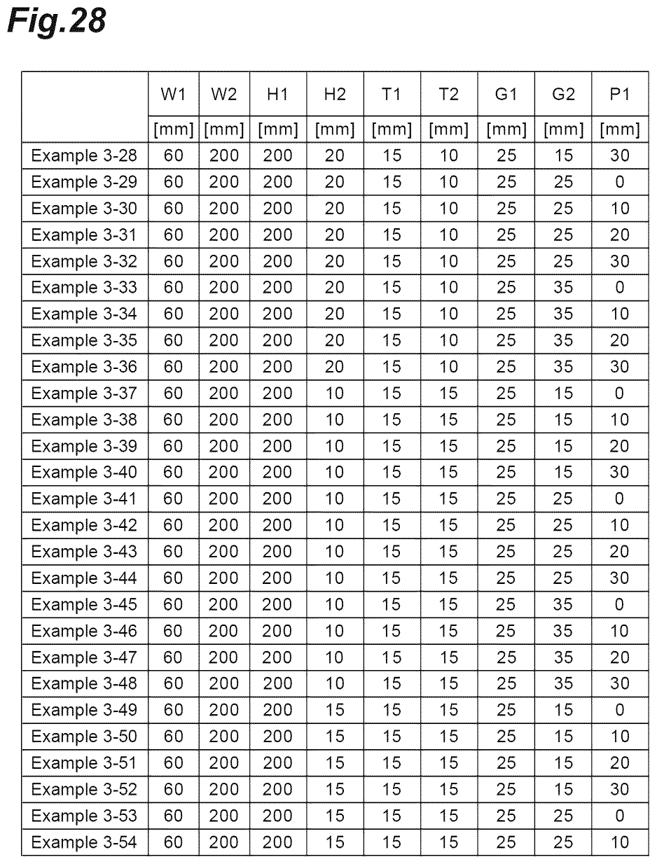

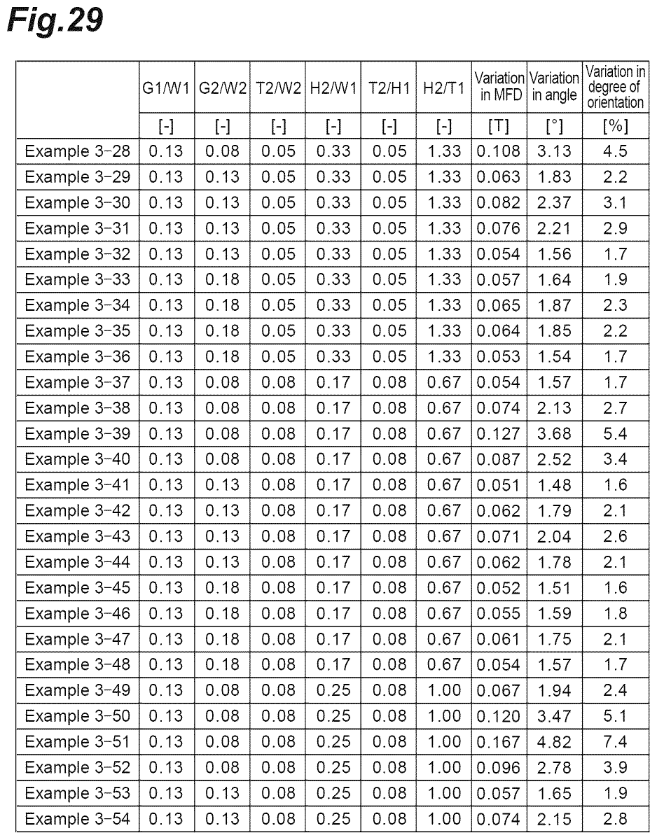

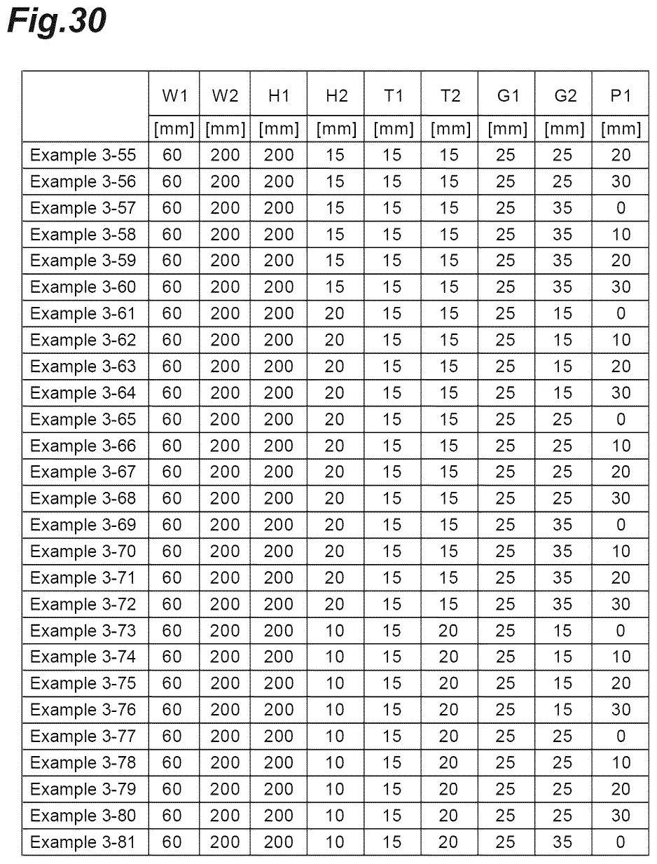

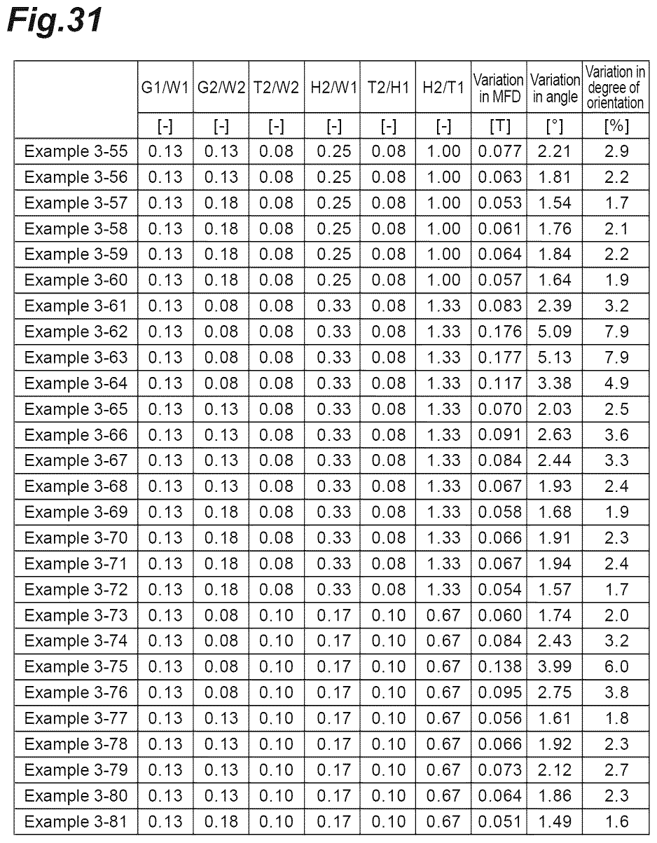

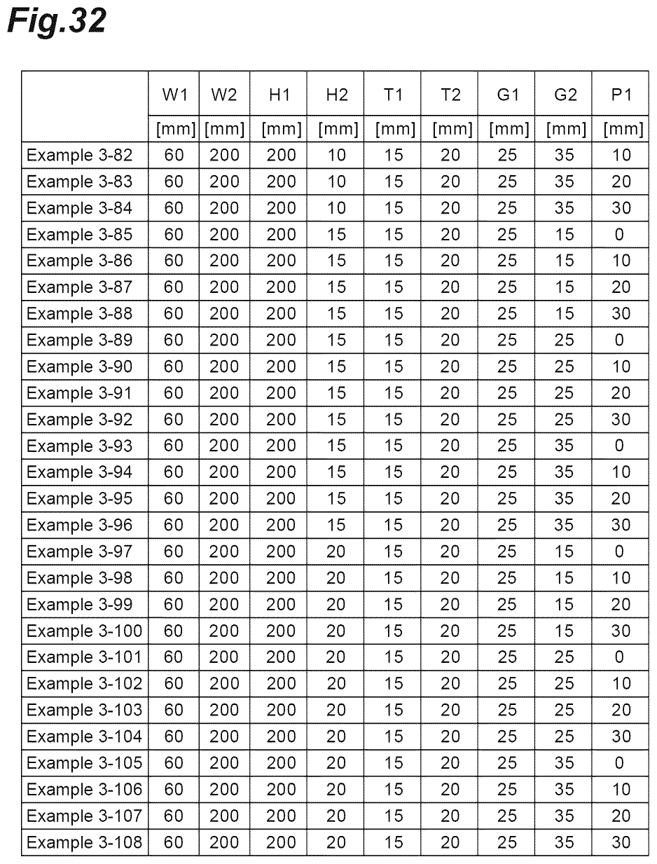

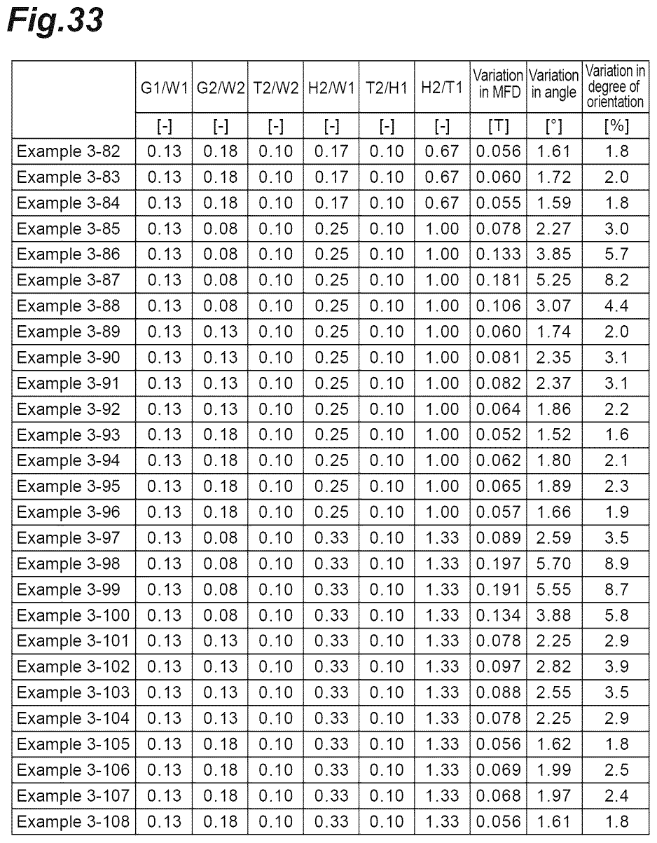

The inventors measured the variation in the degree of orientation by variously changing the set values as shown in FIGS. 12 to 33 in order to confirm the effects of the present disclosure. The set values shown in the tables (i.e., numerical values other than variations in the magnetic flux density (MFD), the angle, and the degree of orientation) were calculated by simulation using electromagnetic field analysis software (JMAG, manufactured by JSOL Corporation). The variation in the degree of orientation is an actually measured value obtained by actually measuring the sintered body obtained by the above-described embodiment. On the other hand, the variations in the magnetic flux density and the angle are simulation values calculated by the above electromagnetic field analysis software at the time of magnetic field application (FIG. 6B). For the variation in the magnetic flux density, the variation in the magnetic flux density between the section having the maximum magnetic flux density and the section having the minimum magnetic flux density in the entire region of the magnetic powder was calculated. For the variation in the angle, the angle of the magnetic flux density in the entire region of the magnetic powder was calculated, and it is the maximum value of the angle variation (i.e., angle deviation) inclined toward the third direction D3 with the second direction D2 as a reference.

### Example 1

Example 1 adopted the form shown in FIG. 4, and its set values, the variations in the magnetic flux density, the angle, and the degree of orientation were as shown in the tables of FIGS. 12 to 15. The specific set values are the length of the opening in the second direction (W1), the length of the opening in the third direction (W2), the length of the first yoke portion in the third direction (H1), the length of the second yoke portion in the second direction (H2), the length of the first yoke portion in the second direction (T1), the length of the second yoke portion in the third direction (T2), the separation distance between the first yoke portion and the opening in the second direction (G1), and the separation distance between the second yoke portion and the opening in the third direction (G2). In all of the examples according to Example 1 (Examples 1-1 to 1-48), the variation in the degree of orientation was less than 10%, and it was confirmed that the degree of orientation was high. In the examples where the variation in the degree of orientation was less than 5% (Examples 1-1 to 1-4, Examples 1-6 to 1-8, Examples 1-10 to 1-12, Examples 1-14 to 1-16, Examples 1-18 to 1-20, Examples 1-22 to 1-24, Examples 1-26 to 1-28, Examples 1-30 to 1-32, Examples 1-34 to 1-36, Examples 1-38 to 1-40, Examples 1-42 to 1-44, Examples 1-47 to 1-48), the ratio of G2/W2 was relatively high, and it was confirmed that the degree of orientation becomes even higher in such cases.

### Example 2

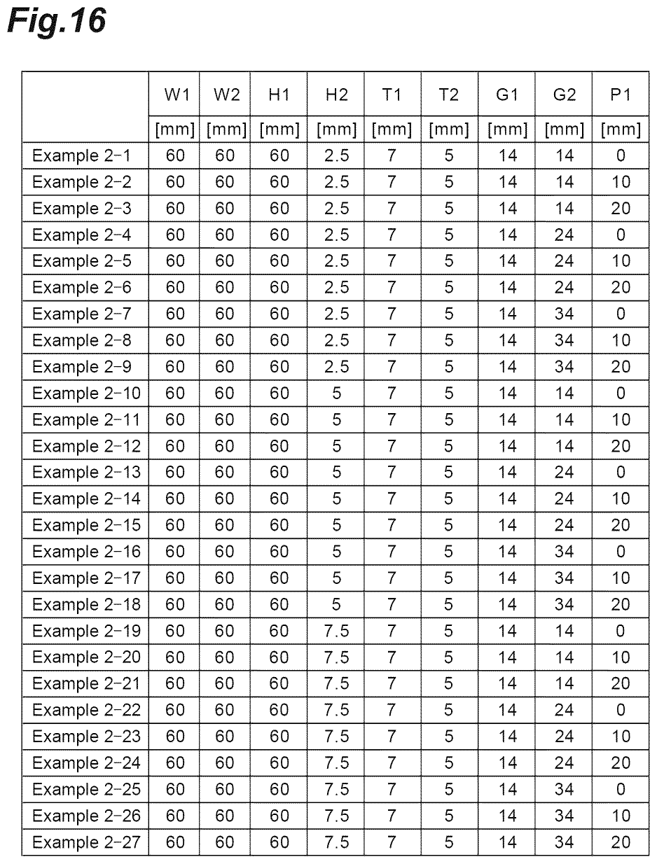

Example 2 adopted the form shown in FIG. 9, and its set values, the variations in the magnetic flux density, the angle, and the degree of orientation were as shown in the tables of FIGS. 16 to 25. The specific set values are the length of the opening in the second direction (W1), the length of the opening in the third direction (W2), the length of the first yoke portion in the third direction (H1), the length of the second yoke portion in the second direction (H2), the length of the first yoke portion in the second direction (T1), the length of the second yoke portion in the third direction (T2), the separation distance between the first yoke portion and the opening in the second direction (G1), the separation distance between the second yoke portion and the opening in the third direction (G2), and the separation distance between the first yoke portion and the second yoke portion in the second direction (P1). In all of the examples according to Example 2 (Examples 2-1 to 2-119), the variation in the degree of orientation was less than 10%, and it was confirmed that the degree of orientation was high. In the examples where the variation in the degree of orientation was less than 5% (Examples 2-1 to 2-46, Examples 2-48 to 2-73, Examples 2-75 to 2-119), it was confirmed that the degree of orientation becomes even higher.

### Example 3

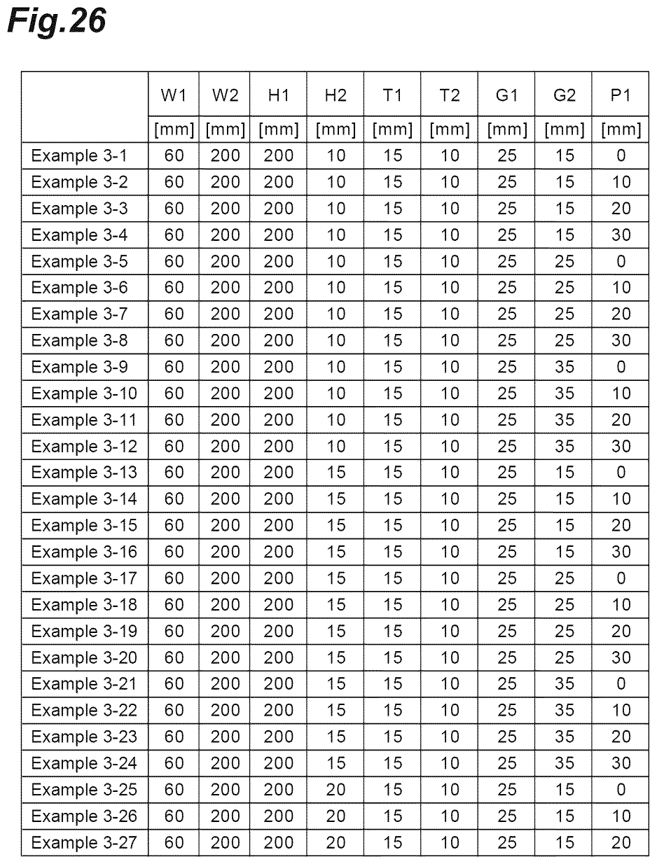

Example 3 adopted the form shown in FIG. 9, and its set values, the variations in the magnetic flux density, the angle, and the degree of orientation were as shown in the tables of FIGS. 26 to 33. The specific set values are the length of the opening in the second direction (W1), the length of the opening in the third direction (W2), the length of the first yoke portion in the third direction (H1), the length of the second yoke portion in the second direction (H2), the length of the first yoke portion in the second direction (T1), the length of the second yoke portion in the third direction (T2), the separation distance between the first yoke portion and the opening in the second direction (G1), the separation distance between the second yoke portion and the opening in the third direction (G2), and the separation distance between the first yoke portion and the second yoke portion in the second direction (P1). In all of the examples according to Example 3 (Examples 3-1 to 3-108), the variation in the degree of orientation was less than 10%, and it was confirmed that the degree of orientation was high. In the examples where the variation in the degree of orientation was less than 5% (Examples 3-1 to 3-14, Examples 3-16 to 3-25, Examples 3-28 to 3-49, Examples 3-52 to 3-61, Examples 3-64 to 3-74, Examples 3-76 to 3-85, Examples 3-88 to 3-97, Examples 3-101 to 3-108), it was confirmed that the degree of orientation becomes even higher.

1. A method for making a sintered magnet, using a pressing mold including a main body having an opening to be filled with magnetic powder and extending in a first direction, and a yoke arranged around the opening of the main body in a cross-section orthogonal to the first direction, the method including steps of:
forming a green compact by pressing the magnetic powder filled in the opening in the first direction while applying a magnetic field along a second direction orthogonal to the first direction; and
forming a sintered magnet by sintering the green compact,
wherein, in a cross-section orthogonal to the first direction, the opening has a rectangular shape defined by two sides extending in the second direction and two sides extending in a third direction orthogonal to the first direction and the second direction, and
wherein the yoke includes, in a cross-section orthogonal to the first direction, a pair of first yoke portions sandwiching the opening in the second direction, and a pair of second yoke portions sandwiching the opening in the third direction.

2. The method for making a sintered magnet according to claim 1, wherein, in a cross-section orthogonal to the first direction, the pair of second yoke portions face each other in the third direction and are arranged symmetrically with respect to a first reference line, the first reference line passes through a center of the opening and extends in the third direction.

3. The method for making a sintered magnet according to claim 1, wherein, in a cross-section orthogonal to the first direction, the pair of first yoke portions are arranged symmetrically with respect to a second reference line, the second reference line passes through a center of the opening and extends in the second direction.

4. The method for making a sintered magnet according to claim 1, wherein, in a cross-section orthogonal to the first direction, the pair of second yoke portions are arranged symmetrically with respect to a second reference line, the second reference line passes through a center of the opening and extends in the second direction.

5. The method for making a sintered magnet according to claim 2, wherein, in a cross-section orthogonal to the first direction, a center of each of the pair of second yoke portions with respect to the second direction is located on the first reference line.

6. The method for making a sintered magnet according to claim 2, wherein, in a cross-section orthogonal to the first direction, each of the pair of second yoke portions is composed of a plurality of yoke members.

7. The method for making a sintered magnet according to claim 6, wherein, in a cross-section orthogonal to the first direction, each of the pair of second yoke portions is composed of two of the yoke members sandwiching the first reference line.

8. The method for making a sintered magnet according to claim 7, wherein, in a cross-section orthogonal to the first direction, each of the yoke members is biased toward a side of the first reference line.

9. The method for making a sintered magnet according to claim 7, wherein, in a cross-section orthogonal to the first direction, each of the yoke members is biased toward a side opposite to the first reference line.

10. The method for making a sintered magnet according to claim 1, wherein, in a cross-section orthogonal to the first direction, a length of the first yoke portion in the third direction is longer than a length of a side of the opening extending in the third direction.

11. The method for making a sintered magnet according to claim 1,
wherein, with respect to the second direction, a ratio of a separation distance between the first yoke portion and the opening to a length of the opening is 0.01 or more and 3 or less, and,
wherein, with respect to the third direction, a ratio of a separation distance between the second yoke portion and the opening to a length of the opening is 0.05 or more and 3 or less.

12. The method for making a sintered magnet according to claim 1,
wherein, with respect to the third direction, a ratio of a length of the second yoke portion to a length of the opening is 0.01 or more and 0.5 or less, and,
wherein, with respect to the second direction, a ratio of a length of the second yoke portion to a length of the opening is 0.01 or more and 0.8 or less.

13. The method for making a sintered magnet according to claim 1,
wherein, with respect to the third direction, a ratio of a length of the second yoke portion to a length of the first yoke portion is 0.01 or more and 1 or less, and,
wherein, with respect to the second direction, a ratio of a length of the second yoke portion to a length of the first yoke portion is 0.05 or more and 12 or less.

14. A pressing mold for pressing magnetic powder filled in an opening of a main body in a first direction while applying a magnetic field along a second direction orthogonal to the first direction, the pressing mold including a main body having an opening to be filled with the magnetic powder and extending in the first direction, and a yoke arranged around the opening of the main body in a cross-section orthogonal to the first direction,
wherein, in a cross-section orthogonal to the first direction, the opening has a rectangular shape defined by two sides extending in the second direction and two sides extending in a third direction orthogonal to the first direction and the second direction, and
wherein the yoke includes, in a cross-section orthogonal to the first direction, a pair of first yoke portions sandwiching the opening in the second direction, and a pair of second yoke portions sandwiching the opening in the third direction.

15. The pressing mold according to claim 14, wherein, in a cross-section orthogonal to the first direction, the pair of second yoke portions face each other in the third direction and are arranged symmetrically with respect to a first reference line, the first reference line passes through a center of the opening and extends in the third direction.

16. The pressing mold according to claim 14, wherein, in a cross-section orthogonal to the first direction, the pair of first yoke portions are arranged symmetrically with respect to a second reference line, the second reference line passes through a center of the opening and extends in the second direction.

17. The pressing mold according to claim 14, wherein, in a cross-section orthogonal to the first direction, the pair of second yoke portions are arranged symmetrically with respect to a second reference line, the second reference line passes through a center of the opening and extends in the second direction.

18. The pressing mold according to claim 15, wherein, in a cross-section orthogonal to the first direction, a center of each of the pair of second yoke portions with respect to the second direction is located on the first reference line.

19.-23. (canceled)

24. A sintered magnet, comprising a pair of main surfaces facing each other in a first direction,
wherein the sintered magnet is oriented in a second direction orthogonal to the first direction, and
wherein, when viewed from the first direction, a variation in a degree of orientation between a section having a maximum degree of orientation and a section having a minimum degree of orientation with respect to the second direction is less than 10%.

25. The sintered magnet according to claim 24, wherein the variation in the degree of orientation is less than 5%.
